(19) United States
(12) Patent Application Publication
(10) Pub. No.: US 2011/0002442 A1
(43) Pub. Date: Jan. 6, 2011

(54) CIRCULAR TOMOSYNTHESIS X-RAY TUBE

(75) Inventors: Axel Thran, Hamburg (DE); Klaus Erhard, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 12/920,331

(22) PCT Filed: Mar. 6, 2009
(86) PCT No.: PCT/IB09/50922

§ 371 Date: Aug. 31, 2010

(30) Foreign Application Priority Data
Mar. 11, 2008 (EP) 08102487.9

(51) Int. Cl. H05G 1/60; H01J 35/06; H01J 35/14

(52) U.S. Cl. 378/22; 378/134

(57) ABSTRACT

Tomosynthesis system with a rotating anode X-ray tube enabling a circular scan trajectory, wherein the X-ray tube 1 may be equipped with a large number of cathodes (21, 22) distributed around an anode. This allows to generate X-rays (41, 42) at focal spot positions (11, 12), for example evenly distributed on a for example circular line (14) on the surface (15) of an anode (10). The object (61) may be located on the (10) axis of rotation (6) of the anode at some distance to the source. For an examination, the object (61) may be exposed to X-ray beams (41, 42) generated successively on all focal spot positions (11, 12), wherein no movement of the X-ray tube 1 is necessary. The transmitted X-ray intensities may be measured by a flat panel detector (50) to achieve a reconstructed three-dimensional image data.

### FIELD OF THE INVENTION

The present invention relates to an X-ray tube and an X-ray examination apparatus for circular tomosynthesis and a corresponding method, and in particular to an X-ray tube and an X-ray examination apparatus being capable of providing an improved image quality and a corresponding method.

### BACKGROUND OF THE INVENTION

Digital tomosynthesis is currently discussed as the next breast screening technique, since it yields a three-dimensional data with doses comparable to conventional mammography. In current tomosynthesis systems for mammography, the X-ray source is moved along a circular arc or a circular line around the object during a data acquisition. However, this is disadvantageous for several reasons. The movement of the X-ray source is awkward and expands the acquisition time. Moreover, the source trajectory is suboptimal, since it leads to asymmetric image artifacts owing to the time which is necessary for the movement along a circular arc or circular line.

From US 2005/0281379 A1 for example a device and a method for producing multiple X-ray beams from multiple locations is known, where electron emitting pixels on the cathode are turned on in a programmable sequence, and each pixel produces an electron beam that bombards on a corresponding focal spot on an anode of an X-ray source. The X-ray generated from each focal spot on the anode produces one image of the object from different angles which is recorded by a corresponding detector. When the X-ray beam is generated from a first focal spot, the image of the object is recorded by a first detector, when the X-ray beam is generated from a second focal point, the image of the object is recorded by a second detector.

However, such a device requires a plurality of detectors leading to a high effort on the detector side owing to the need of a plurality of detectors.

### SUMMARY OF THE INVENTION

It would be desirable to provide an improved method and device for X-ray examination being capable of providing an improved image quality at a lower effort on the device side.

The invention provides a method and a device for X-ray examination, in particular circular tomosynthesis, a corresponding program element and a computer-readable medium, according to the subject-matter of the independent claims. Further embodiments are incorporated in the dependent claims.

It should be noted that the following described exemplary embodiments of the invention apply also for the method, the device, the program element and the computer-readable medium.

According to an exemplary embodiment of the invention, an X-ray tube comprises an anode arrangement having a plurality of focal spot positions on a surface of the anode arrangement with a first focal spot position and a second focal spot position, a cathode arrangement having a plurality of cathodes with a first cathode and a second cathode, wherein the first cathode is adapted for emitting a first electron beam being focussed on the first focal spot position for generating a first X-ray beam having a first radiating solid angle sector, wherein the second cathode is adapted for emitting a second electron beam being focused on the second focal spot position for generating a second X-ray beam having a second radiating solid angle sector, wherein the first radiating solid angle sector and the second radiating solid angle sector have an overlapping area, wherein the overlapping area is dimensioned to be capable of having positioned therein a detector and a predetermined position for positioning of an object to be examined, such that the predetermined position being positioned up-beam of the detector with respect to each of the first X-ray beam and the second X-ray beam.

The radiating solid angle sector may be considered as the sector in which the respective X-ray beam propagates. This sector may be made more narrow by X-ray windows or collimators.

Thus, it is possible to generate a plurality of X-ray beams by means of a plurality of focal spots and a plurality of cathodes, wherein the X-ray beams overlap in a particular area so that only one detector may be used for examining a particular object. Thus, by means of one single detector, a first image may be generated based on the first X-ray beam during a first period of time, and a second image may be generated by the second X-ray beam during a second period of time. It should be noted that the number of focal spot positions, the number of cathodes, the number of electron beams and the number of X-ray beams, respectively is not limited to the number of 2, but may also include any number larger than 2. The respective number will be selected by the skilled person based on the number of images required for generating a three-dimensional image based on the plurality of numbers of two-dimensional images, which illustrate the respective object from different numbers of perspective views. Thus, only one detector may be provided which will reduce the costs for the detector arrangement and/or will allow a detector having a higher resolution and/or a detector arrangement with a lower space requirement in the X-ray examination apparatus.

According to an exemplary embodiment of the invention, the plurality of focal spot positions are equidistantly distributed on at least a segment of a circular line on the surface of the anode.

Thus, the X-ray tube may be used for a circular tomosynthesis without the need to move the X-ray tube along a circular line. Instead of moving the X-ray tube along a circular line, the position of the focal spot may be successively changed along positions located on a circular line or at least a sector of a circular line to achieve a similar effect. However, since the X-ray tube does not have to be moved along a circular line, and the controlling of the respective cathodes for generating a respective X-ray beam may be carried out much more faster than moving the X-ray tube along a circular line, the complete diagnosis may be carried out much more faster, so that artifacts owing to a movement of the object to be examined during examination can be significantly reduced. Further, artifacts owing to a fast transversally moving X-ray beam during the image generation leading to diffuse images may be avoided.

According to an exemplary embodiment, radiating directions of the electron beams are coplanar with the circular line on the surface of the anode.

Thus, the required space may be kept low, in particular the height of the X-ray tube, since the electron beams and also the respective cathodes may be provided in substantially the same plane as the focal track on the surface of the anode.

According to an exemplary embodiment, the plurality of cathodes are equidistantly distributed on at least a segment of a circular line.

Thus, the processing of the generated images may be carried out much more easier, since the shifted angle between two successive X-ray beams may be kept constant, which may lead to a reduced calculating effort during the image processing. It should be noted that equidistantly distributed on at least a segment of a circular line not only includes equidistant spaces along a circumference, but may also include equidistant angles, wherein the cathodes do not mandatorily have to be positioned along a circular line, but may be also provided on different radial distances from the centre axis of anode.

According to an exemplary embodiment, a vertical of a respective surface portion of the anode is inclined with respect to an angle of incidence of the respective electron beam.

It should be noted that the anode may be formed as a tapered body, wherein the tapered surface may include the focal track. Further, it should be noted that the anode may be rotated, for example by a motor being included in the X-ray tube, so that the impact of the electron beams and thus the entry of energy on a particular location on the anode surface may be avoided. It should be noted that the focal spot positions thus move along the focal track of the rotating anode, wherein the respective focal spot position with respect to the entire X-ray tube may be kept constant, in case the relative position of the cathode arrangement to the entire X-ray tube is constant.

According to an exemplary embodiment, at least a part of the plurality of cathodes comprises nanotube emitters.

Nanotube emitters allow a fast controlling and actuating of the respective cathodes.

According to an exemplary embodiment, the cathode arrangement is rotatably mounted in the X-ray tube.

Thus, the number of different perspective views of the images is not limited to the number of cathodes, moreover, by rotating the cathode arrangement, it is also possible to obtain perspective views for images, which are interleaved. Thus, the number of required cathodes may be reduced while maintaining a large number of different perspective views for the image generation.

According to an exemplary embodiment, the cathode arrangement further comprises a long-term cathode having a hot filament emitter for long-term electron beam generation. Thus, the X-ray tube may be also used for conventional X-ray examination, which, however, requires generally a longer exposure period. Thus, the X-ray tube does not have to be changed between a conventional X-ray examination diagnostic procedure and a circular tomosynthesis diagnostic procedure.

According to an exemplary embodiment, an X-ray exposure apparatus comprises an inventive X-ray tube as described above, and further comprises a detector, a predetermined position for positioning of an object to be examined, wherein the detector and the predetermined position for positioning of an object to be examined are located in the overlapping area, wherein the predetermined position being positioned up-beam of the detector with respect to each of the first X-ray beam and the second X-ray beam.

Thus, not only an X-ray tube, but also an X-ray exposure apparatus may be provided for carrying out a circular tomosynthesis, wherein the X-ray exposure apparatus requires only a single detector. Owing to the positioning of the detector in the overlapping area, it is possible to have only one single detector, which, however, may be irradiated by a plurality of different X-ray beams, so that with only a single detector, a plurality of perspective views of an object to be examined may be generated.

According to an exemplary embodiment, the X-ray tube is rotatably mounted in the X-ray exposure apparatus. Thus, instead of or in addition to a rotatably mounted cathode arrangement in the X-ray tube, further perspective views may be provided for generating a plurality of images, so that the number of images having different perspective views may be larger than the number of different cathodes in the cathode arrangement.

According to an exemplary embodiment, an axis of rotation of the X-ray tube is perpendicular to a plane of the circular line on the surface of the anode.

Thus, the different perspective views leading to different images are positioned along a circular line which allows an easier processing of the images, in particular when generating a three-dimensional image based on the combination of the plurality of two-dimensional images.

According to an exemplary embodiment, the detector is a flat panel detector, wherein the vertical of the detector corresponds to the axis of rotation of the X-ray tube.

Thus, also the processing of the images may be simplified, since no further deformations due to an inclined detector have to be expected or considered.

According to an exemplary embodiment, the predetermined position of the detector is located on an axis of rotation of the X-ray tube. Thus, the detector can be used in a large extent of efficiency with respect to the different perspective views generated by the plurality of numbers of X-ray beams.

According to an exemplary embodiment, there is provided a method for operating an X-ray tube in an X-ray exposure apparatus for examining of an object, wherein the method comprises focusing a first electron beam of a first of a plurality of cathodes on a first focal spot position for generating a first X-ray beam having a first radiating solid angle sector and irradiating a detector by the first X-ray beam during a first period of time, focusing a second electron beam of a second of the plurality of cathodes on a second focal spot position for generating a second X-ray beam having a second radiating solid angle sector and irradiating the detector by the second X-ray beam during a second period of time, wherein the detector and a predetermined position for positioning of an object to be examined is located in an overlapping area of the first radiating solid angle sector and the second radiating solid angle sector, such that the predetermined position being positioned up-beam of the detector with respect to each of the first X-ray beam and the second X-ray beam.

Thus, it is possible to generate a plurality of images having different perspective views of an object to be examined by only one single detector, as already outlined above.

According to an exemplary embodiment, the method further comprises generating a plurality of images, each based on a respective irradiation onto the detector by each of the respective X-ray beams.

Thus, a plurality of X-ray beams and the respective irradiation thereof may serve as a base for generating an image by a detector, wherein the single detector may be used in a sequenced mode in order to provide a plurality of successively generated images.

According to an exemplary embodiment, the method further comprises combining a plurality of generated images and reconstructing a three-dimensional image of the object to be examined, based on the plurality of generated images.

Thus, it is possible by an imaging processing to generate a three-dimensional image of the object to be examined, which may be of relevance in particular for breast screening, because this may eliminate the problem of overlaying tissue, which possibly hides small cancers.

According to an exemplary embodiment, the method further comprises controlling a sequence of the focusing and a rotation of the X-ray tube, such that positions of the resulting respective radiating solid angle sectors correspond to a desired sampling distance along a predetermined line.

Thus, the X-ray source may for example rotate at a slow speed during the scan, so that for example images may be obtained from perspective views along an entire/closed circular line, although cathodes and corresponding focal spots are provided only in a particular sector of the circular line. In other words, for each successive irradiation, a particularly shift will be carried out, wherein the sum of the particular shifts together with the length of the respective section of the circular line results in the length of an entire/closed circular line. Thus, a particular sector of the X-ray tube may be used for other purposes, for example for a cathode for a conventional X-ray examination. Further, it is possible to provide a particular shift to arrive at interleaved perspective views in order to provide a larger number of perspective views from intermitting positions of the X-ray beams. It should be noted that the rotation of the X-ray tube may be carried out continuously as well as in a stepped mode with discrete positions. The first continuous mode allows to have no or low vibrations owing to an avoided acceleration, the latter may have an improved image quality owing to avoided moving during image generation. The same is valid for the possible rotation of the cathode arrangement within the X-ray tube.

According to an exemplary embodiment, the method further comprises controlling the sequence of the focusing and the rotation of the X-ray tube such that the positions are interleaving positions at successive revolutions.

Thus, the positions of the resulting respective radiating solid angle sectors are at interleaving positions at successive revolutions along a predetermined periodically tracked line. It should be noted that also the positions of the focal spot positions and/or the position of the respective cathodes with respect to the centre axis of the anode may be provided at interleaving positions. The purpose thereof is to provide further perspective views from interleaved positions onto the object using the available cathodes, focal spot positions and resulting X-ray beams, which have been used for the perspective views between which the interleaved perspective views are located.

According to an exemplary embodiment, there is provided a program element, which, when being executed by a processor, is adapted to carry out the inventive method as described above.

According to an exemplary embodiment, there is provided a computer-readable medium having stored thereon the inventive program element.

It may be seen as the gist of the present invention to provide an X-ray tube, an X-ray examination apparatus and a corresponding method which allow to provide several perspective views of an object to be examined and using only one single detector, which then may be used in an interleaving operation mode to generate a plurality of images based on the different perspective views of the object to be examined.

It should be noted that the above features may also be combined. The combination of the above features may also lead to synergetic effects, even if not explicitly described in detail.

These and other aspects of the present invention will become apparent from and elucidated with reference to the embodiments described hereinafter.

### BRIEF DESCRIPTION OF THE DRAWINGS

Exemplary embodiments of the invention will be described in the following with reference to the following drawings.

FIG. 1 illustrates a schematic build up of the X-ray tube and the X-ray examination apparatus according to an exemplary embodiment of the invention.

FIG. 2 illustrates a bottom view seen from the dashed line A-A of FIG. 1 according to an exemplary embodiment of the invention.

FIG. 3 illustrates a detailed view of the X-ray tube arrangement of FIG. 1.

FIG. 4 illustrates a bottom view of the X-ray tube along the dashed line A-A of FIG. 1 for a static, not rotating cathode arrangement/not rotating X-ray tube (left) and a rotating cathode arrangement/rotating X-ray tube for an interleaved imaging (right).

FIG. 5 illustrates a schematic flow-chart of the method according to an exemplary embodiment.

### DETAILED DESCRIPTION OF EXEMPLARY EMBODIMENTS

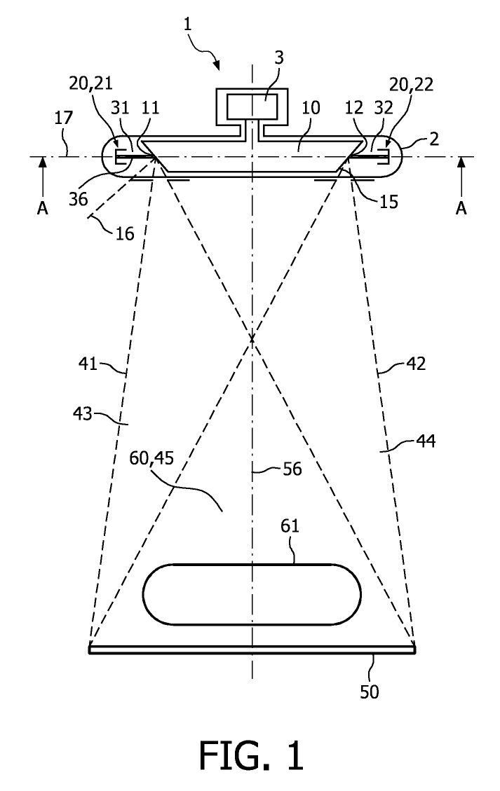

FIG. 1 illustrates an X-ray tube 1. In a housing 2 of the X-ray tube 1, there is provided an anode arrangement 10, which may be rotated by a motor 3 in order to avoid damages on the focal spot track. The anode arrangement 10 may be provided with a plurality of focal spot positions 11,12, which however, do not mandatorily correspond to fix positions on the surface of the anode, since the surface of the anode 10 may rotate during operation. The focal spot position 11,12 shall be considered as the respective position, where the electron beam 31, 32 meets the anode arrangement. It should be noted that the anode arrangement 10 may be provided also with a larger number of focal spots or focal spot positions. Within the housing 2 there is also provided a cathode arrangement 20, having a plurality of cathodes including a first cathode 21 and a second cathode 22. It should be also noted that the number of cathodes, as well as the focal spot positions, is not limited to the number of two, but may also include more than two cathodes. The first cathode 21 may emit an electron beam 31 to a first focal spot position 11, and a second cathode 22 may emit a second electron beam 32 to a second focal spot position 12. The first electron beam 31 generates a first X-ray beam 41, wherein the first X-ray beam has a first radiating solid angle sector which may be used for irradiating an object 61 so that the object 61 can be illustrated on a detector 50 from a first perspective view. Accordingly, the second electron beam 32 generates a second X-ray beam 42. The second X-ray beam has a second radiating solid angle sector 44 for irradiating the object 61 during examination from a first perspective view. The first radiating solid angle sector 43 and the second radiating solid angle sector 44 have an overlapping area 45. The object to be examined 61 and the detector 50 are located within the overlapping area in order to allow an imaging of the object 61 by both, the first X-ray beam 41 and the second X-ray beam 42. The detector may be operated in an interleaving mode, so that during a first period of time imaging may be carried out by the first X-ray beam 41, and during a second period of time, imaging may be carried out by the second X-ray beam 42. It should be noted that the entire overlapping area 45 may be used as a predetermined position 60 for positioning of an object to be examined. Further, it should be noted that the detector 50 shall be provided within the overlapping area. However, it should be noted that also only a part of the detector may be provided in the overlapping area without departing from the idea of the present invention, however, in this case only the part of the detector being provided in the overlapping area 45 may be used for imaging of both of the X-ray beams 41, 42.

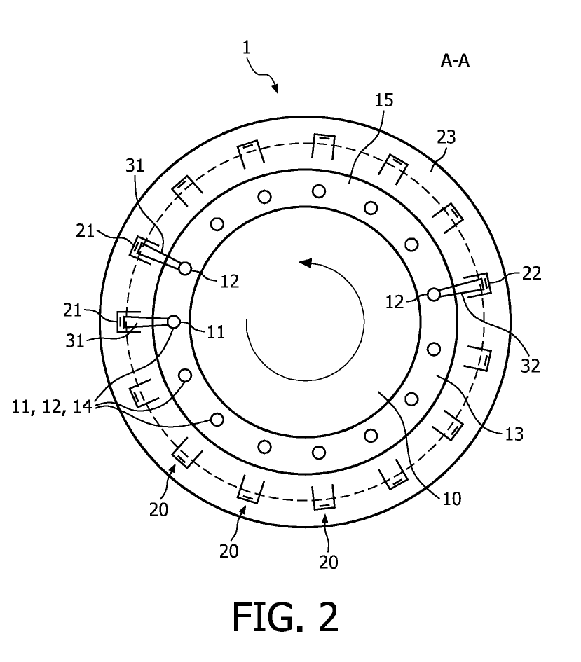

The anode may rotate around an axis of rotation 6, which may correspond to the vertical 56 of the detector 50, in order to obtain optimum conditions for imaging. The axis of rotation of the entire X-ray tube 1 may correspond to the axis of rotation 6 of the anode arrangement 10. The direction of the electron beams 31, 32 may be in a plane 17, which plane 17 may also include the circular line 13, along which line 13 the focal spot positions 11, 12 are located. The focal spot or the focal spot positions 11, 12 are located along a focal track or focal spot track 14 on the surface 15 of the anode arrangement 10. The cathodes 21, 22 may be provided on a circular line 23. The cathodes 21, 22 may be equidistantly distributed along the circumference or a sector of the circumference. Equidistantly distributed does not only include that the cathodes are located on a circular line 23, but may also include embodiments, in which the cathodes 21, 22 are located on equidistant angles, which does not mandatorily require the provision of the cathodes 21, 22 along a circular line 23, but also may be for example radially displaced. On FIG. 2, the cathodes 21, 22 are however, provided on a circular line 23. It should be noted that the entire invention also will work when providing the focal spot positions in different radial distances from the centre axis, however, the image processing will be a little bit different. The vertical 16 of the anode surface 15 may be inclined to the direction 17 of the electron beams 31, 32. Thus, the X-ray beams 41,42 do not have to penetrate the anode to irradiate the detector 50.

FIG. 2 illustrates a bottom view of the anode arrangement and the X-ray tube 1 of FIG. 1. As can be seen in FIG. 2, in this embodiment, the cathodes 21, 22 are located on a circular line 23 and are equidistantly distributed along the circular line 23. However, as outlined above, the cathodes may be also provided in different radial distances from the axis of symmetry, as well as the positions of the focal spot positions 11, 12. It should be noted that for the method, it is not mandatorily required to actuate the cathodes 21, 22 in the order in which they are provided on the circular line 23, they may also be actuated in an interleaving mode or any arbitrary sequence, for example successively leaving out one or two cathodes, which then may be actuated in a second period along a circular line.

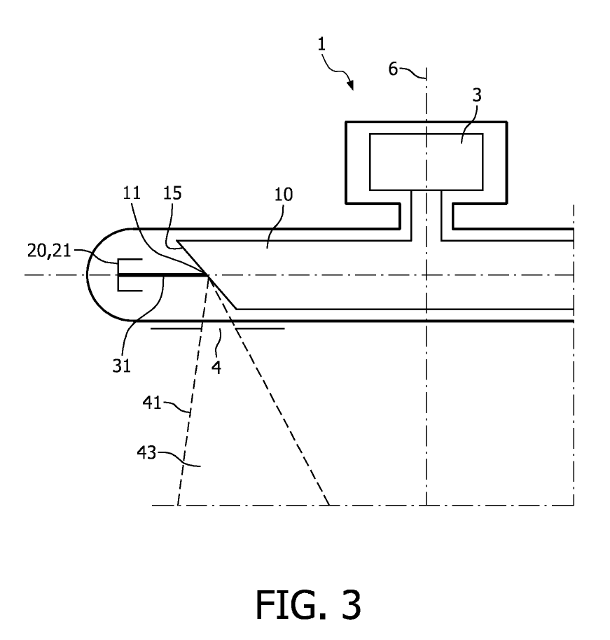

FIG. 3 illustrates a detailed view of the X-ray tube of FIG. 1. The X-ray tube is provided with an anode arrangement 10 which may be rotated by a motor, which may be provided within the X-ray tube. The cathode arrangement 20 with a first cathode 21 may be provided within the X-ray tube 1 wherein the first electron beam 31 is focused on a first focal spot position 11 on the anode surface 15. It should be noted that the direction of the electron beam 31 is not limited to be in the plane which is orthogonal to the axis of rotation 6 of the anode arrangement 10. The electron beam 31 may also be inclined. The X-ray tube may be provided with one or a plurality of X-ray windows and collimators 4 through which the X-ray beam 41 may leave the X-ray tube in a first radiating solid angle sector 43. The cathode arrangement may also be provided with an additional third, fourth and so on cathode in order to provide a plurality of cathodes as well as a plurality of electron beams, which may lead to a plurality of focal spot positions and resulting X-ray beams.

Thus, an X-ray tube for a tomosynthesis system with a circular scan trajectory, or generally a line scan trajectory may be provided. However, the system is not limited to a circular scan trajectory, moreover, the scan trajectory may have any form, for example of an elliptic line, where appropriate, as well as any free form line. The plurality of cathodes allows to generate X-ray beams emerging from different focal spots located on their focal track on a for example rotating anode, which focal track may be circular. For an examination, the object is exposed to the X-ray beams generated successively on all focal spot positions. The transmitted X-ray intensities measured by a for example flat panel detector may be reconstructed to a three-dimensional image. Thus, no movement of the X-ray tube is necessary, in particular no movement of the tube along a scan trajectory will be necessary. However, it should be noted that the advantageous properties of the present invention may be also achieved when combining only a partially moved above-mentioned X-ray tube.

The cathodes may be equipped with carbon nanotube emitters for an easy control of the X-ray generation. The plurality of focal spot positions may be realized on a circular line of the rotating anode, however, it should be noted that the focal spot positions may also be displaced from the circular focal track, for example to provide two concentric circular focal tracks in order to distribute the impact of electron beams onto the surface of the anode. Further, the focal spot positions may be equidistantly distributed on the circular line on the anode, however, it should be noted that the focal spot positions do not have to be mandatorily equidistantly distributed. The object to be examined may be located on the axis of rotation 6 of the anode arrangement 10 at some distance to the source. For an examination, the object is exposed to X-ray beams 41, 42 which beams are generated successively on all focal spot positions 11, 12. The transmitted X-ray intensities measured by for example a flat panel detector may be reconstructed yielding a three-dimensional image data.

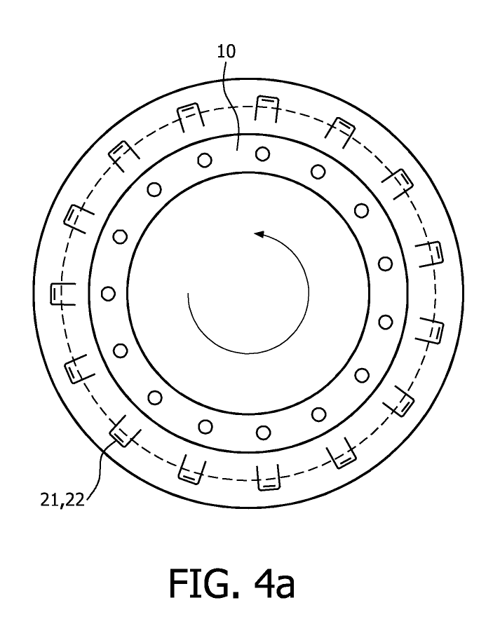

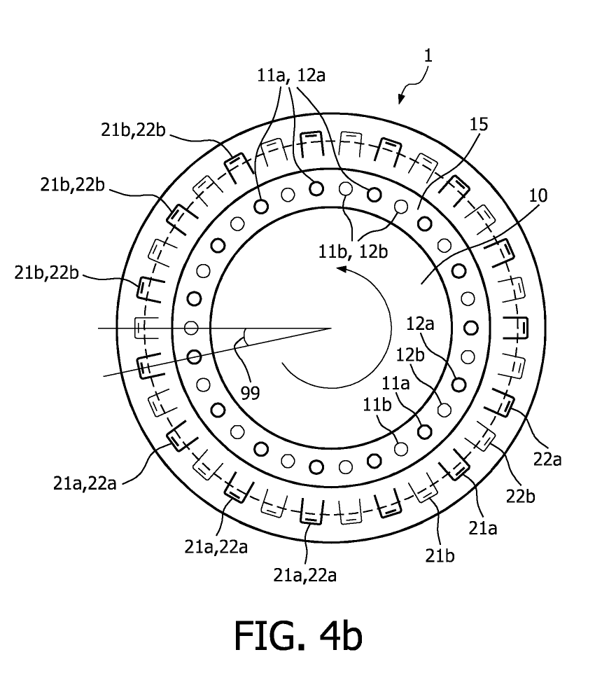

FIG. 4 illustrates a bottom view of the cross-section of an X-ray tube. On the left-hand side a. the cathodes 21, 22 are fixed and only the anode arrangement 10 may rotate in order to avoid an overheating due to the electron beams.

On the right-hand side b. there is illustrated a bottom view of a cross-section of the X-ray tube along the line A-A. The cathode arrangement may be rotated with respect to the axis of rotation. It should be noted that for the rotation of the cathode arrangement, the cathode arrangement as such may be rotated within the X-ray tube 1, however, also the entire X-ray tube may be rotated to achieve the same technical effect. References 21a and 22a refer to a first and second cathode during a first sequence of image acquisitions from all focal spot positions, wherein the references 21b and 22b refer to a first and second cathode during a second sequence of image acquisitions from all focal spot positions. The same is valid for the first and second focal spot positions 11a and 12a, as well as the first and second focal spot positions 11b, 12b. During the second sequence the cathodes and the focal spots, respectively, may be in interleaved positions. The cathode arrangement or the tube have to be rotated only by a small angle 99 between both sequences, which corresponds to half of the angle between two cathodes in this example.

In order to realize a large number of projections of a tomosynthesis, the X-ray source may be rotated by small angles about the rotational axis 6 of the anode. The cathode arrangement may be rotated by half of the angle between the cathodes, either by rotating the cathode arrangement within the X-ray tube or by rotating the entire X-ray tube. When the object is scanned before and after this rotation, the number of focal spot positions in the total scan is doubled. Even higher multiples of the number of cathodes in the X-ray source can be realized with this measure.

Alternatively, the X-ray source may rotate slowly during the scan. For example, 15 cathodes may be arranged at angles differing by 23.2° around the anode. Then, the X-ray tube has to be rotated by 0.8° during each projection in order to perform a first partial scan with 15 projections at equidistant angles of 24°. After this first partial scan, the first cathode is rotated by an angle of 0.8°*15=12°=24°/2. Thus, in a second partial scan projections from interleaved focal spot positions can be measured. Altogether projections at equidistant angles 0°, 12°, 24° . . . , 348°=−12° are acquired. Thus, the total shift of the cathode arrangement by half of the angle between two cathodes does not have to be carried out during two scans, namely the last scan of the first revolution and the first scan of the second revolution, but may be carried out more or less continuously in order to provide a smooth transition between the scans. It should be noted that also the cathode arrangement may be rotated by one third or any other division of the angle between the cathodes

When the system should be used also for a conventional digital mammography, one single cathode may provided for generating an electron beam for a much longer period than for the individual projections in a tomosynthesis scan. This period may be too long for example for present a carbon nanotube based cathode, however nanotube cathodes may develop. Then, one of the cathodes should be of the conventional type with a hot filament, or any other cathode for long term operation, or an additional cathode of this type should be added.

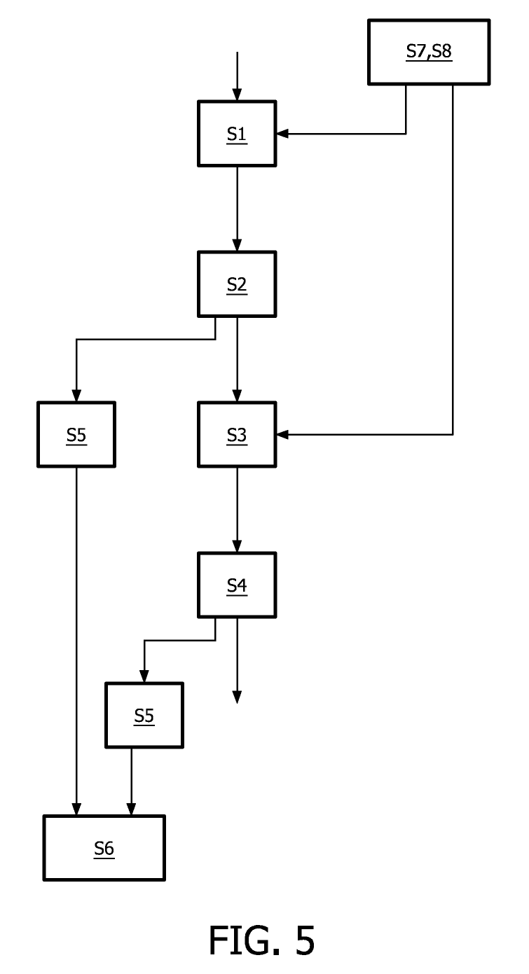

FIG. 5 illustrates a schematic flow-chart of the inventive method including focusing S1 a first electron beam for generating a first X-ray beam and irradiating S2 a detector by the first X-ray beam during a first period of time, focusing S3 a second electron beam for generating a second X-ray beam and irradiating S4 the detector by the second X-ray beam during a second period of time. The detector may generate a first image during a first period of time and a second image during a second period of time. Each of the images may be combined to achieve a reconstructed three-dimensional image S6. Further, the sequence of the focusing and a rotation of the X-ray tube may be controlled S7 such that positions of the resulting respective radiating solid angle sectors correspond to a desired sampling distance along a predetermined line. Further, the sequence of focusing and the rotation of the X-ray tube may be controlled S8, such that the positions are interleaving positions at successive revolutions along a predetermined periodically tracked line. Further details are described with respect to FIG. 4 above.

It should be noted that the term ‘comprising’ does not exclude other elements or steps and the ‘a’ or ‘an’ does not exclude a plurality. Also elements described in association with the different embodiments may be combined.

It should be noted that the reference signs in the claims shall not be construed as limiting the scope of the claims.

1. An x-ray tube comprising:
an anode arrangement having a plurality of focal spot positions on a surface of the anode arrangement with a first focal spot position and a second focal spot position,
a cathode arrangement having a plurality of cathodes with a first cathode and a second cathode,
wherein the first cathode is adapted for of emitting a first electron beam being focussed on the first focal spot position for generating a first x-ray beam having a first radiating solid angle sector,
wherein the second cathode is adapted for emitting a second electron beam being focussed on the second focal spot position for generating a second x-ray beam having a second radiating solid angle sector,
wherein the first radiating solid angle sector and the second radiating solid angle sector have an overlapping area,
wherein the overlapping area is dimensioned to be capable of having positioned therein a detector and a predetermined position for positioning of an object to be examined, such that the predetermined position being positioned up-beam of the detector with respect to each of the first x-ray beam and the second x-ray beam.

2. The x-ray tube of claim 1, wherein the plurality of focal spot positions are equidistantly distributed on at least a segment of a circular line on the surface of the anode.

3. The x-ray tube of claim 2, wherein a radiating directions of the electron beams are coplanar with the circular line on the surface of the anode.

4. The xray tube of claim 1, wherein the plurality of cathodes are equidistantly distributed on at least a segment of a circular line.

5. The x-ray tube of claim 1, wherein a vertical of a respective surface portion of the anode is inclined with respect to an angle of incidence of the respective electron beam.

6. The x-ray tube of claim 1, wherein at least a part of the plurality of cathodes comprise nanotube emitters.

7. The x-ray tube of claim 1, wherein the cathode arrangement is rotatable mounted in the x-ray tube.

8. The x-ray tube of claim 1, wherein the cathode arrangement further comprises at least one long term cathode having a hot filament emitter for long term electron beam generation.

9. An x-ray exposure apparatus comprising
an x-ray tube of claim 1,
a detector,
a predetermined position for positioning of an object to be examined,
wherein the detector and the predetermined position for positioning of an object to be examined, are located in the overlapping area,
wherein the predetermined position being positioned up-beam of the detector with respect to each of the first x-ray beam and the second x-ray beam.

10. The x-ray exposure apparatus of claim 9, wherein the x-ray tube is rotatably mounted.

11. The x-ray exposure apparatus of claim 10, wherein an axis of rotation of the x-ray tube is perpendicular to a plane of the circular line of a focal track on the surface of the anode.

12. The x-ray exposure apparatus of claim 9, wherein the detector is a flat panel detector, wherein the vertical of the detector corresponds to the axis of rotation of the x-ray tube.

13. The x-ray exposure apparatus of claim 9, wherein the predetermined position is located on an axis of rotation of the x-ray tube.

14. A method for operating an x-ray tube in an x-ray exposure apparatus for examining of an object, the method comprising
focussing (S1) a first electron beam of a first of a plurality of cathodes on the first focal spot position for generating a first x-ray beam having a first radiating solid angle sector and irradiating (S2) a detector by the first x-ray beam during a first period,
focussing (S3) a second electron beam of a second of the plurality of cathodes on the second focal spot position for generating a second x-ray beam having a second radiating solid angle sector and irradiating (S4) the detector by the second x-ray beam during a second period,
wherein the detector and a predetermined position for positioning of an object to be examined is located in an overlapping area of the first radiating solid angle sector and the second radiating solid angle sector, such that the predetermined position being positioned up-beam of the detector with respect to each of the first x-ray beam and the second x-ray beam.

15. The method of claim 14, further comprising generating (55) a plurality of images each based on a respective irradiation of the detector by each of the respective x-ray beams.

16. The method of claim 15, further comprising combining (S6) a plurality of generated images and reconstructing a 3-dimensional image of the object to be examined.

17. The method of claim 14 further comprising controlling (S7) a sequence of the focussing and a rotation of the x-ray tube, such that positions of resulting respective radiating solid angle sectors corresponds to a desired sampling distance along a predetermined line.

18. The method of claim 17, further comprising controlling (S8) the sequence of the focussing and a rotation of the x-ray tube, such that the positions are interleaving positions at successive revolutions.

19. A programme element, which, when being executed by a processor, is adapted to carry out the method of claim 14.

20. A computer readable medium having stored the programme element of claim 19.
